(19) United States
(12) Patent Application Publication
(10) Pub. No.: US 2023/0385546 A1
(43) Pub. Date: Nov. 30, 2023

(54) SYSTEM AND METHOD FOR CONTEXT INSERTION FOR CONTRASTIVE SIAMESE NETWORK TRAINING

(71) Applicant: Samsung Electronics Co., Ltd., Suwon-si (KR)

(72) Inventors: Brendon Christopher Beachy Eby, Chicago, IL (US); Suhel Jaber, San Jose, CA (US); Sai Ajay Modukuri, San Francisco, CA (US); Omar Abdelwahab, Mountain View, CA (US); Ankit Goyal, Belmont, CA (US)

(21) Appl. No.: 18/315,931

(22) Filed: May 11, 2023

Related U.S. Application Data
(60) Provisional application No. 63/345,614, filed on May 25, 2022.

(51) Int. Cl. G06F 40/284

(52) U.S. Cl. CPC G06F 40/284

(57) ABSTRACT

A method includes receiving an input utterance that is a continuation of a previous utterance. The method also includes, using a trained Siamese network, determining input utterance embeddings representing tokens from the input utterance, pooling the input utterance embeddings with a context token embedding representing a class associated with the previous utterance to generate a representative input utterance embedding, and determining a representative embedding associated with each of multiple possible classes. Each possible class is associated with first and second threshold boundaries. The method further includes, using the trained Siamese network, determining a similarity score for each possible class based on a distance between the representative input utterance embedding and a selected threshold boundary of the representative embedding for that possible class and identifying a class for the input utterance based on the determined similarity scores. In addition, the method includes performing an action corresponding to the identified class.

### CROSS-REFERENCE TO RELATED APPLICATION AND PRIORITY CLAIM

This application claims priority under 35 U.S.C. § 119(e) to U.S. Provisional Patent Application No. 63/345,614 filed on May 25, 2022, which is hereby incorporated by reference in its entirety.

### TECHNICAL FIELD

This disclosure relates generally to natural language processing systems. More specifically, this disclosure relates to a system and method for context insertion for contrastive Siamese network training.

### BACKGROUND

Siamese network training can be very effective for similarity-based machine learning tasks. Siamese network training can involve training multiple networks to place phrases relative to each other, rather than relative to an embedding space directly. For example, to determine the similarity between two phrases, an output embedding from a pretrained large language model (LLM) such as BERT for each phrase can be calculated independently, and their similarity can be determined based on the “closeness” of the outputs using a distance metric (such as negative Euclidian distance or cosine similarity). This differs from standard classification techniques in which the output of a pretrained LLM is used directly for classification. Training in this way allows a network to learn both the output embedding of an input phrase and the target's embedding simultaneously, giving it an enhanced ability to learn complex relationships.

### SUMMARY

This disclosure provides a system and method for context insertion for contrastive Siamese network training.

In a first embodiment, a method includes receiving an input utterance that is a continuation of a previous utterance. The method also includes, using a trained Siamese network, determining input utterance embeddings representing tokens from the input utterance. The method further includes, using the trained Siamese network, pooling the input utterance embeddings with a context token embedding representing a class associated with the previous utterance to generate a representative input utterance embedding. The method also includes, using the trained Siamese network, determining a representative embedding associated with each of multiple possible classes, where each possible class is associated with (i) a first threshold boundary that encompasses embeddings of utterances that specify that possible class and (ii) a second threshold boundary that encompasses embeddings of continuation utterances with injected context. The method further includes, using the trained Siamese network, determining a similarity score for each possible class based on a distance between the representative input utterance embedding and a selected threshold boundary of the representative embedding for that possible class, where the selected threshold boundary includes the first threshold boundary or the second threshold boundary. The method also includes, using the trained Siamese network, identifying a class for the input utterance based on the determined similarity scores. In addition, the method includes performing an action corresponding to the identified class.

In a second embodiment, an electronic device includes at least one processing device configured to receive an input utterance that is a continuation of a previous utterance. The at least one processing device is also configured to use a trained Siamese network to determine input utterance embeddings representing tokens from the input utterance. The at least one processing device is further configured to use the trained Siamese network to pool the input utterance embeddings with a context token embedding representing a class associated with the previous utterance to generate a representative input utterance embedding. The at least one processing device is also configured to use the trained Siamese network to determine a representative embedding associated with each of multiple possible classes, where each possible class is associated with (i) a first threshold boundary that encompasses embeddings of utterances that specify that possible class and (ii) a second threshold boundary that encompasses embeddings of continuation utterances with injected context. The at least one processing device is further configured to use the trained Siamese network to determine a similarity score for each possible class based on a distance between the representative input utterance embedding and a selected threshold boundary of the representative embedding for that possible class, where the selected threshold boundary includes the first threshold boundary or the second threshold boundary. The at least one processing device is also configured to use the trained Siamese network to identify a class for the input utterance based on the determined similarity scores. In addition, the at least one processing device is configured to perform an action corresponding to the identified class.

In a third embodiment, a non-transitory machine-readable medium contains instructions that when executed cause at least one processor of an electronic device to receive an input utterance that is a continuation of a previous utterance. The medium also contains instructions that when executed cause the at least one processor to use a trained Siamese network to determine input utterance embeddings representing tokens from the input utterance. The medium further contains instructions that when executed cause the at least one processor to use the trained Siamese network to pool the input utterance embeddings with a context token embedding representing a class associated with the previous utterance to generate a representative input utterance embedding. The medium also contains instructions that when executed cause the at least one processor to use the trained Siamese network to determine a representative embedding associated with each of multiple possible classes, where each possible class is associated with (i) a first threshold boundary that encompasses embeddings of utterances that specify that possible class and (ii) a second threshold boundary that encompasses embeddings of continuation utterances with injected context. The medium further contains instructions that when executed cause the at least one processor to use the trained Siamese network to determine a similarity score for each possible class based on a distance between the representative input utterance embedding and a selected threshold boundary of the representative embedding for that possible class, where the selected threshold boundary includes the first threshold boundary or the second threshold boundary. The medium also contains instructions that when executed cause the at least one processor to use the trained Siamese network to identify a class for the input utterance based on the determined similarity scores. In addition, the medium contains instructions that when executed cause the at least one processor to perform an action corresponding to the identified class.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a drier, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism.” “module,” “device,” “unit,” “component,” “element,” “member.” “apparatus,” “machine,” “system,” “processor,” or “controller.” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device according to this disclosure,

FIG. 2 illustrates an example process for context insertion for contrastive Siamese network training according to this disclosure:

FIG. 3 illustrates an example pooling technique using a learnable attention layer according to this disclosure;

FIG. 4 illustrates example classes and example threshold boundaries that can be used during distance calculations in the process of FIG. 2 according to this disclosure;

FIG. 5 illustrates an example distance measurement from a class threshold boundary according to this disclosure;

FIG. 6 illustrates an example distance measurement from a class target according to this disclosure:

FIG. 7 illustrates an example distance measurement from multiple class threshold boundaries including a context threshold according to this disclosure;

FIG. 8 illustrates an example multi-target training according to this disclosure:

FIG. 9 illustrates an example multi-target distance measurement including a default threshold according to this disclosure;

FIG. 10 illustrates an example n-dimensional space in which an input utterance can be mapped according to this disclosure; and

FIG. 11 illustrates an example method for classifying an input utterance into a class according to this disclosure.

### DETAILED DESCRIPTION

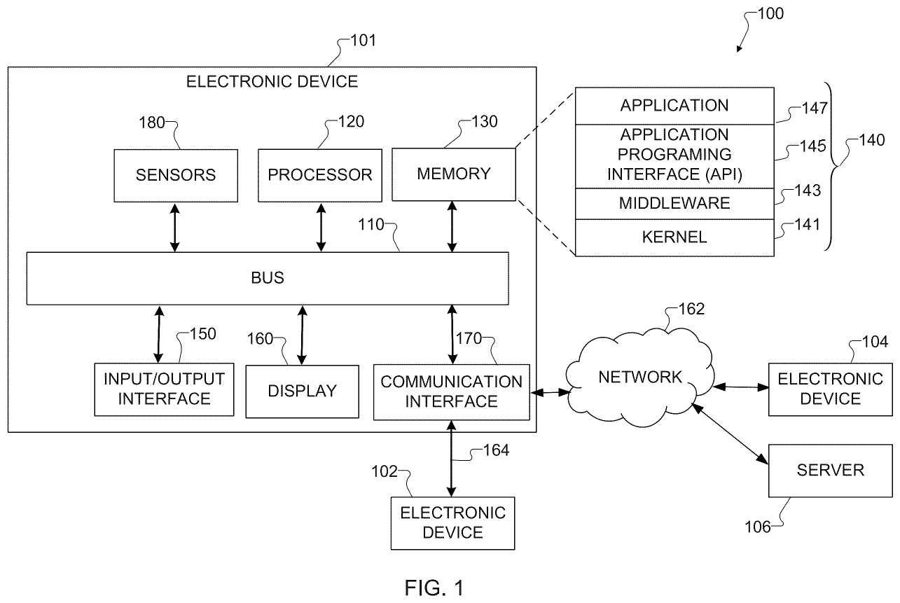

FIGS. 1 through 11, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure.

As discussed above, Siamese network training can be very effective for similarity-based machine learning tasks. Siamese network training can involve training multiple networks to place phrases relative to each other, rather than relative to an embedding space directly. For example, to determine the similarity between two phrases, an output embedding from a pretrained large language model (LLM) such as BERT for each phrase can be calculated independently, and their similarity can be determined based on the “closeness” of the outputs using a distance metric (such as negative Euclidian distance or cosine similarity). This differs from standard classification techniques in which the output of a pretrained LLM is used directly for classification. Training in this way allows a network to learn both the output embedding of an input phrase and the target's embedding simultaneously, giving it an enhanced ability to learn complex relationships.

An important task for many applications is learning the impact of context. In a personal assistant application, for example, the assistant may need to learn to classify input utterances such as “What about San Francisco?” That utterance by itself is not easily classifiable without knowing the context. However, if the assistant knows that the previous statement from the user was “What is the weather like in San Jose?”, the assistant can determine that the subsequent phrase is also asking about the weather. Utterances such as this are known as “continuations.” Given the benefits of training Siamese networks when performing similarity classification, it would also be advantageous to enable Siamese networks to work with context-based classification tasks.

This disclosure provides various techniques for context insertion for contrastive Siamese network training. As described in more detail below, the disclosed systems and methods utilize Siamese networks when training utterance classification tasks that sometimes require context. The disclosed systems and methods address how context can be inserted into the model when there is no direct technique for doing so in Siamese networks. Note that while some of the embodiments discussed below are described in the context of use in a computing device such as a server, this is merely one example, and it will be understood that the principles of this disclosure may be implemented in any number of other suitable contexts and may use any suitable devices. For example, some embodiments could be implemented on personal computers, smartphones, tablet computers, smart watches or other wearable devices, smart devices, and the like.

FIG. 1 illustrates an example network configuration 100 including an electronic device according to this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform one or more operations for context insertion for contrastive Siamese network training.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support one or more functions for context insertion for contrastive Siamese network training as discussed below. These functions can be performed by a single application or by multiple applications that each carry out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 include one or more cameras or other imaging sensors for capturing images of scenes. The sensor(s) 180 can also include one or more buttons for touch input, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an ins sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an AR wearable device, such as a headset with a display panel or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform one or more operations to support techniques for context insertion for contrastive Siamese network training.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

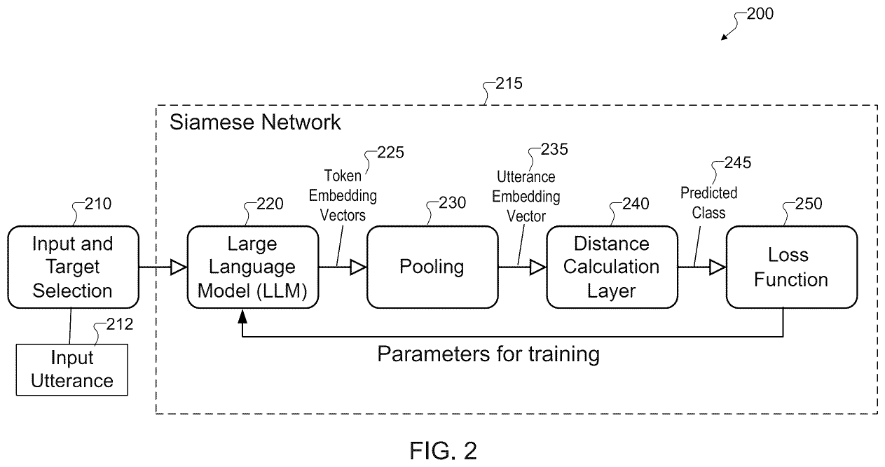

FIG. 2 illustrates an example process 200 for context insertion for contrastive Siamese network training according to this disclosure. For ease of explanation, the process 200 is described as being performed using one or more components of the network configuration 100 of FIG. 1 described above, such as the server 106. However, this is merely one example, and the process 200 could be performed using any other suitable device(s) and in any other suitable system(s).

As shown in FIG. 2, the server 106 performs a selection operation 210. During the selection operation 210, the server 106 selects an input utterance 212 that could represent a sentence or utterance including one or more words (represented as tokens in the input utterance 212). In some embodiments, the input utterance 212 is an utterance that is selected for use in training a Siamese network 215. The Siamese network 215 includes a large language model (LLM) 220, a pooling layer 230, and a distance calculation layer 240. In some cases, the input utterance 212 can be selected by itself for use in the network training.

In some embodiments, a representation of context can be added to the input utterance 212 so that both the input utterance 212 and the representation of context can be used in the network training. In some cases, context may be defined as the output class that an utterance may reference. In the example of a personal assistant, this may be the classification of the last utterance from a given user. As particular examples, the representation of context can be any of a name of a context class, a descriptive text phrase of the context class, a single custom token for each class, a representative utterance chosen as a target (or another general representative context phrase), or a sentence or utterance that appeared prior to the input utterance 212. In particular embodiments, the representation of context can be appended after a separator token or prepended before a separator token. Depending on the implementation, a different type embedding may be added to the utterance and context portion of the inputs.

The server 106 also selects one or more target embedding vectors for each class among multiple classes of training utterances. From the target embedding vectors, the similarity to the input utterance 212 will be calculated. In some embodiments, the training utterances are part of a training set of historical utterances labeled with one or more classes. Also, in some embodiments, the server 106 passes each training utterance in the training set through a pre-trained language model (such as the LLM 220 described in greater detail below), groups the training utterances into clusters by class, and calculates the mean or median embedding vector of each class.

Once the server 106 obtains the mean, median, or other embedding vector for each class, the server 106 selects the target embedding vectors for each class. The server 106 can select the target embedding vectors using any suitable techniques. For example, in some embodiments, the server 106 selects the mean or median embedding vector of a class as a fixed target embedding vector for that class. In other embodiments, the server 106 selects the mean or median embedding vector of a class as an initial learnable target embedding vector for that class, which can be subsequently fine-tuned during training. In still other embodiments, the server 106 selects an utterance as a representative target for each class, such as the utterance determined to be the example closest to either the mean or median embedding vector of that class. These selected class embedding vectors represent the “centroid” or “target” for each class and are thus referred to as the “class centroid” or “class target.”

Once the target embedding vectors are selected, the server 106 passes the tokens of the input utterance 212 through the LLM 220. The LLM 220 generates token embedding vectors 225, which are input utterance embeddings based on the tokens of the input utterance 212. Once generated, the LLM 220 outputs the token embedding vectors 225. In some embodiments, the LLM 220 generates a token embedding vector 225 for each word of the input utterance 212. The LLM 220 can represent any suitable large pre-trained language model that outputs an embedding vector for every input token, such as a BERT model.

The token embedding vectors 225 generated by the LLM 220 are used by the server 106 to perform a pooling operation in the pooling layer 230. In the pooling layer 230, the server 106 combines or “pools” the token embedding vectors 225 from the LLM 220 into a single utterance embedding vector 235, which is an overall representation of the input utterance 212. The server 106 can combine the token embedding vectors 225 using any suitable techniques. In some embodiments, the server 106 can calculate a simple average of the token embedding vectors 225 for the tokens. In other embodiments, the server 106 can combine the token embedding vectors 225 using a LogAvgExp function, which may be defined as follows.

LogAvgExp(inputs,α)=Log(Avg(Exp(inputs*α)))/α (1)

Here, α is a hyperparameter that can be used to smoothly select a point between the maximum of the inputs when α→∞ or a mean of the inputs when α→0. In yet other embodiments, using a modification of Equation (1), the value of α may be a learnable parameter that can be optimized during training. Depending on the implementation, the value of a may be a single value to be used for all input dimensions, or α may represent a vector with a different learnable value per input dimension.

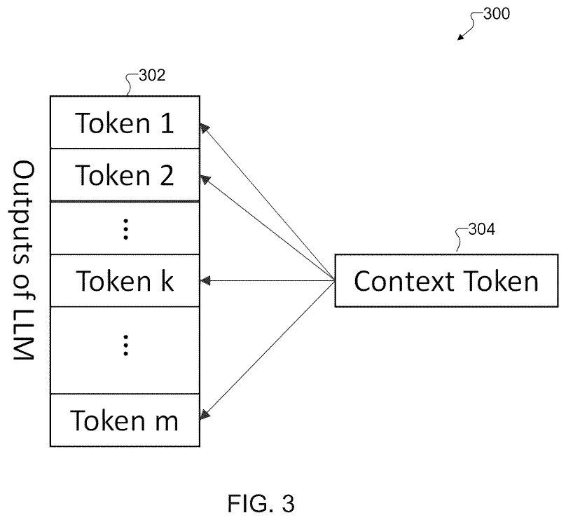

In still other embodiments, the server 106 can implement the pooling layer 230 using a learnable attention layer in what is referred to as “context attention.” Attention in the learnable attention layer can be performed using any suitable techniques, examples of which will now be described. In some embodiments, a learnable query embedding for each context is used as the query token, and the outputs of the LLM 220 are used as keys and values (with the query token optionally concatenated). FIG. 3 illustrates an example pooling technique 300 according to this disclosure. As shown in FIG. 3, the outputs 302 of the LLM 220 are indicated as different token embeddings 1 through m. These outputs 302 represent the token embedding vectors 225 of FIG. 2 and are used as keys and values. A context token embedding 304 represents the query embedding for a particular context and is used as the query token. The context token embedding 304 can be optionally concatenated to each of the token embeddings 1 through m. Depending on the context token embedding 304, different weights can be assigned to each of the token embeddings 1 through m.

In other embodiments, the centroid target embeddings selected in the selection operation 210 may be used as the query token, and the outputs of the LLM 220 are used as keys and values (with the query token optionally concatenated). In still other embodiments, if the context was appended or prepended to the input in the selection operation 210, a pooling of the corresponding output token embedding(s) can be used as the query token, and the outputs of the LLM 220 are used as keys and values (with the query token optionally concatenated). In yet other embodiments, a pooled utterance is obtained using an average or LogAvgExp function of the output token embeddings (as described above). The pooled utterance is used as the query token, and the pre-pooled centroid target embeddings are used as keys and values (with the query token optionally concatenated). In some of the embodiments described above, a mask can be applied to the keys and values such that appended context representations are not included in the attended tokens. A combination or concatenation of two or more of the techniques described above may be used. If multiple techniques are used in parallel, the final output token embeddings can be pooled using an average or LogAvgExp function of the output token embeddings (as described above). Alternatively, the final output token embeddings can pass through a dense layer to generate a single output embedding.

Based on the pooling operation in the pooling layer 230, the utterance embedding vector 235 has been determined for the given input utterance 212 and for all class targets. The server 106 executes the distance calculation layer 240, which determines how similar the input utterance 212 is to each class of training utterances. If the input utterance 212 is not similar to any class of training utterances, the input utterance 212 can be considered to be “unhandled.” Accordingly, in the distance calculation layer 240, the server 106 can determine a similarity of the input utterance 212 to each class label, as well as its similarity to an unhandled classification. The similarity can be based on a calculated “distance” between the utterance embedding vector 235 and a selected spatial parameter representing each class. The distance between the utterance embedding vector 235 and the selected spatial parameter can be calculated using any suitable distance metric, such as negative Euclidian distance or cosine similarity. Depending on the embodiment, the selected spatial parameter can be a threshold boundary of the class or the class target of the class.

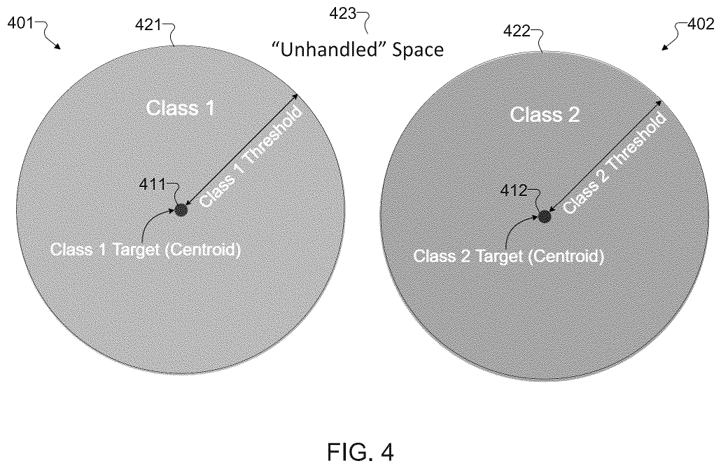

In some embodiments, the distance calculation layer 240 can determine a threshold boundary for each class. A threshold boundary represents a hyper-spherical boundary between a given class and “unhandled” space. As discussed in greater detail below, the threshold boundaries can be learnable during the training process. FIG. 4 illustrates example classes and example threshold boundaries that can be used during distance calculations in the process 200 of FIG. 2 according to this disclosure. As shown in FIG. 4, two classes, namely a class 401 (“Class 1”) and a class 402 (“Class 2”), represent a subset of the classes of training utterances that are selected during the selection operation 210. Each class 401 and 402 is respectively represented by a corresponding class centroid or class target 411 and 412, which is the representative embedding vector for that class. Each class 401 and 402 also has a threshold boundary 421 and 422, which represents the hyper-spherical boundary between the class 401 and 402 and an “unhandled” space 423. In general, the embeddings of utterances from a particular class 401 and 402 will be clustered around each class target 411 and 412 within the threshold boundary 421 and 422, and “unhandled” utterances will be located in the “unhandled” space 423 between and around the threshold boundaries 421 and 422.

In some embodiments, a “single target” can be used during the training process. This means that the output embeddings for inputs and targets are not adjusted, and distances are calculated and prioritized directly from this embedding. For these embodiments, the representation of context can be inserted into the language model previously, such as by being concatenated (such as appended or prepended) to the input utterance 212 during the selection operation 210 or through context attention in the pooling layer 230. Similarity between inputs and targets may be calculated using either a “distance from threshold” technique or a “distance from centroid” technique. Both of these will now be explained.

For the distance from threshold technique, the similarity of an input utterance 212 to a particular class label can be based on a calculated distance between the utterance embedding vector 235 and the threshold boundary of that class. In some embodiments, the similarity of the input utterance 212 to the class can be calculated as follows.

similarity_{i,t}=distance_to_centroid_{i,t}+thresholdₜ (2)

Here, similarity_{i,t} is the similarity score of an input utterance i relative to the class target t of the class, distance_to_centroid_{i,t} is the distance from the input utterance i to the class target t, and thresholdₜ is the distance from the target t to the threshold boundary for that class. For these embodiments, an “unhandled” class may be assigned a similarity score of zero.

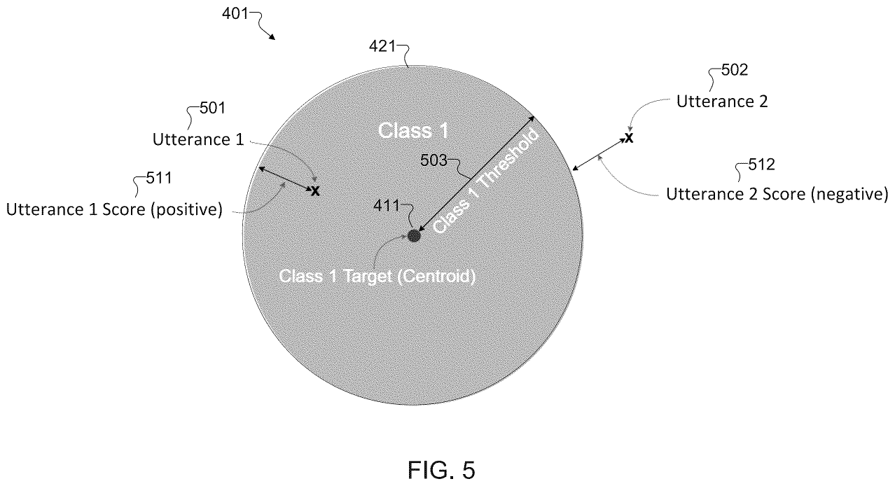

FIG. 5 illustrates an example distance measurement from a class threshold boundary according to this disclosure. As shown in FIG. 5, two input utterances, namely an utterance 501 (“Utterance 1”) and an utterance 502 (“Utterance 2”), are compared to the class 401 in order to determine the similarities of the utterances 501 and 502 to the class 401. The similarity score 511 and 512 for each utterance 501 and 502 is based on the distance between each utterance 501 and 502 and the threshold boundary 421 for the class 401. This distance can be calculated as shown in Equation (2), where distance_to_centroid is the distance from the utterance 501 and 502 to the class target 411 and threshold is the distance from the class target 411 to the threshold boundary 421 (which is indicated by the distance 503).

Note that the value of distance_to_centroid may be a negative value and that the value of threshold may be a positive value. Thus, the similarity scores can be positive for an input utterance inside a class's threshold boundary (such as the utterance 501) and negative for an input utterance outside a class's threshold boundary (such as the utterance 502). This means that, if all similarity scores are outside their threshold boundaries, the unhandled score of zero will be the highest score for that input utterance, leading to an “unhandled” classification. In some embodiments, training may be performed by cross-entropy, with a single positive class for each utterance and the remainder negative.

For the distance from centroid technique, the similarity score of an input utterance to a particular class label may be set as the measured distance from the input utterance to the class target of that class (such as distance_to_centroid) without any modification. In some embodiments, the similarity of an input utterance to the “unhandled” label may be calculated as follows.

similarity_unhandledᵢ=−1*smooth_max({(distance_to_centroid_{i,t}+thresholdₜ) for t in T}) (3)

Here, distance_to_centroid_{i,t} is the distance from the input utterance i to the class target t, thresholdₜ is the distance from the target t to the threshold boundary for that class, T is the set of all class targets (centroids), and “smooth_max” is a function such as LogSumExp that calculates a smooth negative maximum of the thresholded distances to each class target. In some embodiments, training may be done by cross entropy, with a single positive class for each utterance and the remainder negative.

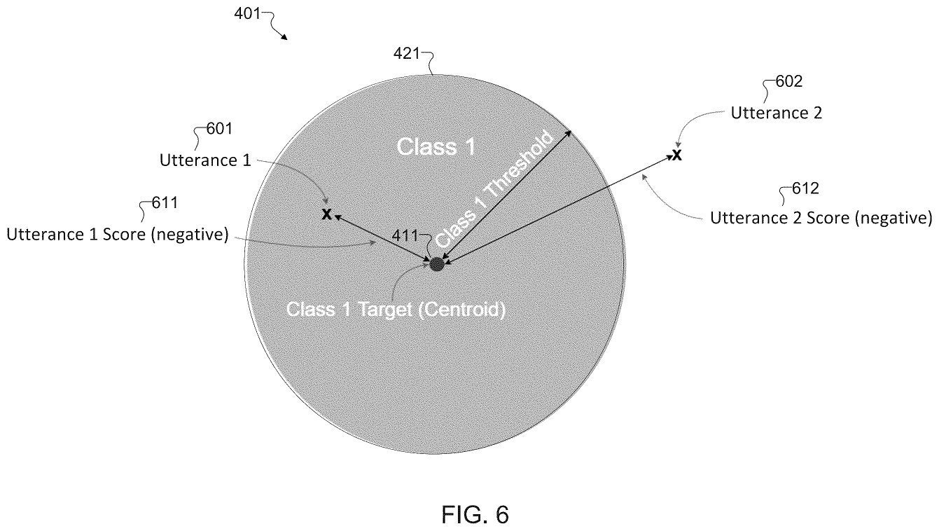

FIG. 6 illustrates an example distance measurement from a class target according to this disclosure. As shown in FIG. 6, two input utterances, namely an utterance 601 (“Utterance 1”) and an utterance 602 (“Utterance 2”), are compared to the class 401 in order to determine the similarities of the utterances 601 and 602 to the class 401. The similarity score 611 and 612 for each utterance 601 and 602 is based on the distance between each utterance 601 and 602 and the class target 411 for the class 401. This distance is represented as distance_to_centroid and may be a negative value. Thus, the similarity scores may be negative.

As discussed above, the “distance from threshold” and “distance from centroid” techniques are used for a “single target” scenario, where the representation of context is previously inserted into the language model (such as during the selection operation 210 or the pooling operation in the pooling layer 230). However, in some embodiments, the representation of context can be inserted in the distance calculation layer 240. This can be referred to as “multi-target.”

As an example, it is likely that some utterances such as “What about San Francisco?” can have different correct labels depending on the context in which the utterance is found. As previously discussed, such utterances are known as “continuations.” Using the “single target” technique described above, the language model must learn each label separately based on the inserted context and output a different embedding for each. However, the “multi-target” techniques described below allow for a single embedding to belong to multiple labels based on context. In these embodiments, the similarity score for each class target is based on context in addition to the embedding itself. In “multi-target,” the context does not need to have been inserted into the language model previously, although in some embodiments it may be.

In the “multi-target” embodiments described below, context threshold boundaries are learned in addition to regular threshold boundaries (such as the threshold boundary 421 of FIGS. 4 through 6). The context threshold boundaries are larger than (such as at a greater distance from the target than) the regular threshold boundaries. If a class is in context, the larger context threshold boundary will be used. If the class is not in context, the regular threshold boundary will be used.

Using both regular threshold boundaries and context threshold boundaries, the similarity between inputs and targets may be calculated using either a “distance from threshold” technique or a “distance from centroid” technique. Both of these will now be explained.

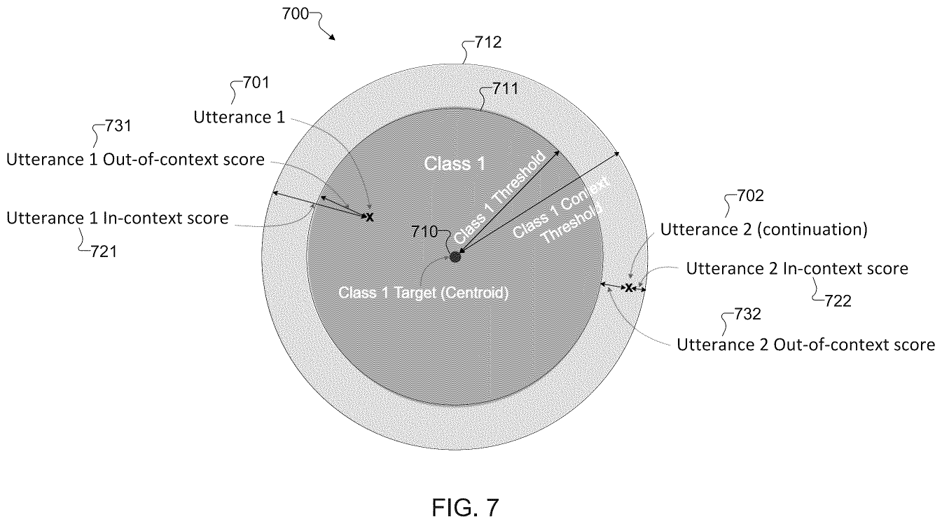

Using the “distance from threshold” technique, the unhandled distance is set to zero, and the distance to each class is calculated based on a distance from each label to each class target, added to the threshold or context threshold for each class. For example, FIG. 7 illustrates an example distance measurement from multiple class threshold boundaries including a context threshold according to this disclosure. As shown in FIG. 7, two input utterances, namely an utterance 701 (“Utterance 1”) and an utterance 702 (“Utterance 2”), are compared to a class 700 (“Class 1”) in order to determine the similarities of the utterances 701 and 702 to the class 700. Here, the utterance 701 is a regular (non-continuation) utterance, such as “What is the weather in Los Angeles?” The utterance 702 is a continuation utterance, such as “What about San Francisco?” The class 700 is represented by a class centroid or class target 710. The class 700 also has multiple threshold boundaries 711 and 712. The threshold boundary 711 is a regular threshold boundary, similar to the threshold boundaries 421 and 422 of FIG. 4. The threshold boundary 712 is a context threshold boundary, which is applicable when considering the utterances 701 and 702 with injected context. The context threshold boundary 712 is at a greater distance from the class target 710 than the regular threshold boundary 711.

Each utterance 701 and 702 can have an in-context similarity score or an out-of-context similarity score depending on whether the utterance 701 and 702 is in context or out of context with the class 700. For example, if the class 700 is “weather,” the utterance 701 (“What is the weather in Los Angeles?”) is in context, and an in-context similarity score 721 is determined. The continuation utterance 702 (“What about San Francisco?”) may also be in context, and an in-context similarity score 722 is determined for the continuation utterance 702. Alternatively, if the class 700 is “television,” the utterance 701 (“What is the weather in Los Angeles?”) is out of context, and an out-of-context similarity score 731 is determined. The continuation utterance 702 (“What about San Francisco?”) may also be out of context, and an out-of-context similarity score 732 can be determined for the continuation utterance 702.

In some cases, the distances can be calculated as shown in Equation (2) above. Thus, the similarity scores can be positive for an input utterance inside a class's threshold boundary and negative for an input utterance outside a class's threshold boundary. For example, the continuation utterance 702 is inside the context threshold boundary 712, and the in-context similarity score 722 is positive. However, the continuation utterance 702 is outside the threshold boundary 711, and the out-of-context similarity score 732 is negative.

Using the “distance from centroid” technique, in some embodiments, the distance from each label can be set as the distance from each class target (such as the distance 503 shown in FIG. 5) plus the context threshold (such as the context threshold boundary 712) if a class is in context. This biases the language model toward the in-context class, allowing the same embedding to have multiple classifications depending on its context. In these embodiments, the similarity of the utterance to the “unhandled” label may be calculated using Equation (3) above.

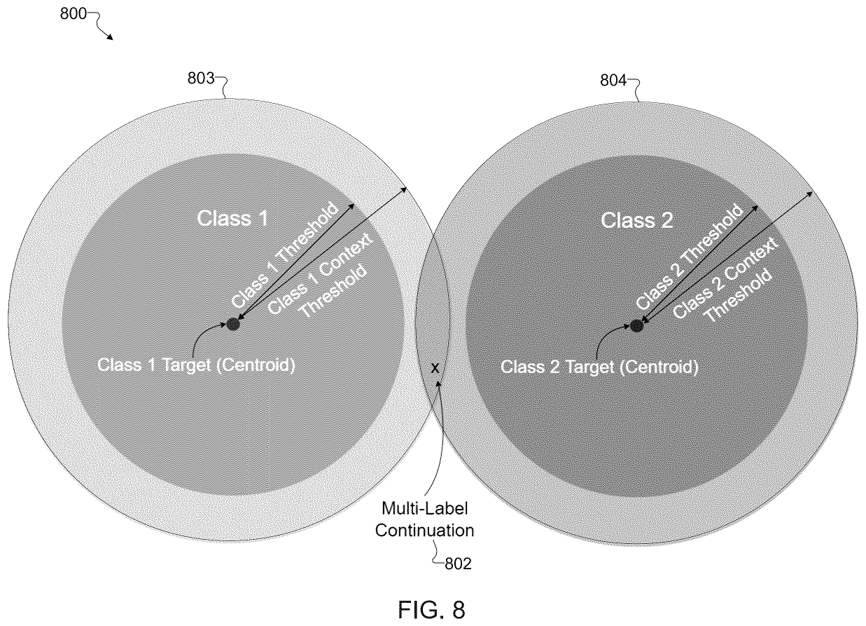

In the “multi-target” embodiments, the language model can be trained using any suitable techniques. As a first example, the language model can be trained using cross entropy as a loss function, comparing both distances and the unhandled distance. As a second example, multiple labels can be trained simultaneously. For example, FIG. 8 illustrates an example multi-target training 800 according to this disclosure. As shown in FIG. 8, a continuation utterance 802 (such as “What about San Francisco?”) is associated with multiple classes, including a class 803 (“Class 1,” which can be a “hotels” class) and a class 804 (“Class 2,” which can be a “weather” class). The continuation utterance 802 has a positive label for both classes 803 and 804 since “What about San Francisco” can be a continuation for both “hotels” and “weather.” For other classes (not shown) for which the continuation utterance 802 is not a continuation, the continuation utterance 802 would have a negative label. In some embodiments, the continuation utterance 802 can have a negative label for the regular threshold of the continuation labels, as well. In the embodiment shown in FIG. 8, any multi-label loss function can be used for training, such as KL-Divergence, Multiple Binary Cross Entropy (MBCE), and the like.

As a third example, the distances from an utterance embedding to each centroid can be passed through a sigmoid function and formed into a vector of output logits, and a distance is calculated from that vector to the label vector of each possible multi-label configuration vector. In some cases, the language model can be trained using cross entropy as a loss function. As a fourth example, an additional linear layer can be added to the output of the language model, which will map the output space into an n−1 dimensional output (where n is the number of classes). This is the minimum number of dimensions needed for all classes to overlap in all possible permutations. In some cases, the thresholds may be pre-established, and the language model may be trained to place all utterances within that topology.

With respect to multi-target with a default threshold, in some cases, if a continuation utterance arrives without a context for which the utterance is a continuation, the utterance should be classified as an unhandled utterance. In other cases however, there may be a requirement to send that utterance to a default label. For example, for a continuation utterance “Call them,” there may or may not be a context from a previous utterance that explains who “them” is. Nevertheless, it may be preferable to assume or suggest a default label if one is not clearly known. In the “Call them” example, a phone contact that is most frequently called by the user may be selected as a default label, or a phone app could be selected as the default label.

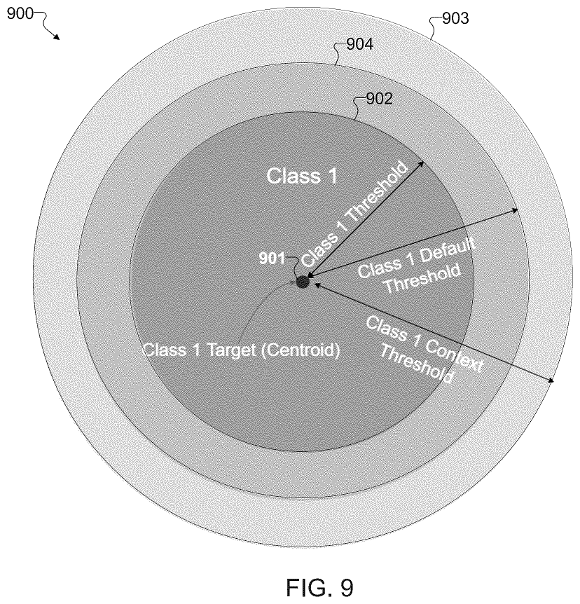

FIG. 9 illustrates an example multi-target distance measurement including a default threshold according to this disclosure. As shown in FIG. 9, a class 900 is represented by a class centroid or class target 901. The class also has multiple threshold boundaries 902-904. The threshold boundary 902 is a regular threshold boundary, similar to the threshold boundary 711 of FIG. 7. The threshold boundary 903 is a context threshold boundary, similar to the context threshold boundary 712 of FIG. 7. The threshold boundary 904 is a default threshold boundary for the default label. In some embodiments, the default threshold boundary 904 may lie between the regular threshold boundary 902 and the context threshold boundary 903 and may only exist for those classes that are default classifications for at least one continuation utterance. When an utterance has a class as its context, any classes that act as a default for continuation cases of that class may use their default thresholds instead of their regular thresholds. The multi-target distance measurements and training techniques described above are applicable for these embodiments that include a default label, such as shown in FIG. 9.

Turning again to FIG. 2, once the similarities of the input utterance 212 to each class of training utterances have been determined by the distance calculation layer 240, the server 106 predicts the class 245 of the input utterance 212. If there is no similarity between the input utterance 212 and one of the target classes, the server 106 can predict an “unhandled” class 245 for the input utterance 212. The prediction can be passed to a loss function 250, which the server 106 uses to calculate the error of the model and back-propagated for training. For example, the input utterance 212 can be associated with an expected class, and the loss function 250 can be based on the difference between the expected class and the predicted class 245. As discussed above, in some embodiments, the loss function 250 can be based on cross entropy. However, this is merely one example, and the loss function 250 can represent any suitable loss function for use in training a language model.

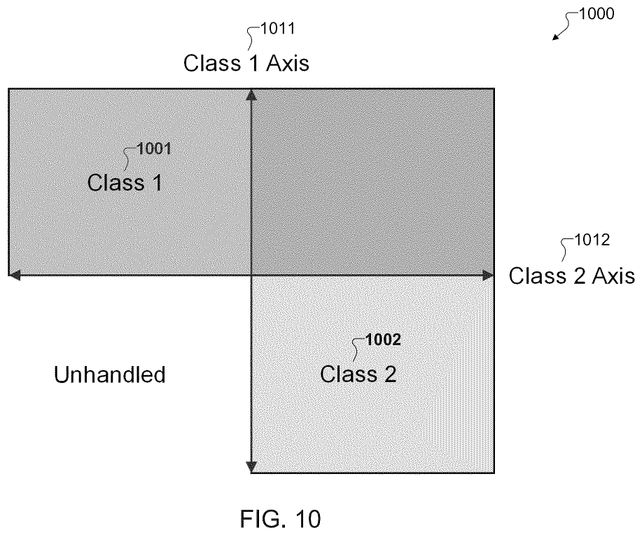

In some embodiments, the output from the LLM 220 can be mapped with a linear layer to a single output dimension (logit) for each class. For example, if a logit has a positive value, the input utterance 212 may be a member of the class associated with that logit. If a logit has a negative value, the input utterance 212 may not be a member of the class associated with that logit. An “unhandled” label can be assigned when the logits have negative values for all classes. One example of this is shown in FIG. 10.

FIG. 10 illustrates an example n-dimensional space 1000 in which an input utterance can be mapped according to this disclosure. As shown in FIG. 10, this example of the n-dimensional space 1000 represents a two-dimensional space (n=2) for two classes, namely a class 1001 (“Class 1”) and a class 1002 (“Class 2”). Note that this is for ease of illustration only. In typical implementations, n may be greater than two and perhaps be much greater than two. Each class 1001 and 1002 has a corresponding axis 1011 and 1012, which divides the class 1001 and 1002 into positive and negative spaces. If a logit for an input utterance falls to the right of the Class 1 axis 1011, the logit has a positive value for that dimension, and the input utterance is a member of Class 1. If the logit for the input utterance falls to the left of the Class 1 axis 1011, the logit has a negative value for that dimension, and the input utterance is not a member of Class 1. Similarly, if the logit for the input utterance falls above the Class 2 axis 1012, the logit has a positive value for that dimension, and the input utterance is a member of Class 2. If the logit for the input utterance falls below the Class 2 axis 1012, the logit has a negative value for that dimension, and the input utterance is not a member of Class 2. If the logit for the input utterance is both to the left of the Class 1 axis 1011 and below the Class 2 axis 1012, the logit is not a member of either Class 1 or Class 2 and is considered “unhandled.” During training, the logit for the “unhandled” logit may be determined as follows.

−1*LogSumExp(logits*α)/α, (4)

Here, α is a hyperparameter. This allows for differentiable training of unhandled inputs.

In some embodiments of the n-dimensional space 1000, the selected label is the class with the highest value. Context may be inserted by adding a threshold value for the class dimension that is in context for a given utterance. A default threshold may also be added between 0 and the context threshold, such as described in conjunction with FIG. 9. Also, in some embodiments of the n-dimensional space 1000, class logits are activated using a tan h function prior to classification. An utterance is considered to be a class if its activated logit has a value above 0.5 and is considered not a class if it has a value below −0.5. Between 0.5 and −0.5, an utterance is considered as a class only if that class is in context. In addition, in the n-dimensional space 1000, training can be performed using one of the multi-target techniques (such as KL-Divergence or MBCE) or by using the sigmoid function example discussed above. In this case, if a continuation utterance is shared between multiple classes, those classes are both positive targets.

Although FIG. 2 through 10 illustrate one example of a process 200 for context insertion for contrastive Siamese network training and related details, various changes may be made to FIGS. 2 through 10. For example, while described as involving a specific sequence of operations, various operations of the techniques described with respect to FIGS. 2 through 10 could overlap, occur in parallel, occur in a different order, or occur any number of times (including zero times). Also, the specific operations shown in FIGS. 2 through 10 are examples only, and other techniques could be used to perform each of the operations shown in FIGS. 2 through 10.

Note that the operations and functions shown in or described with respect to FIGS. 2 through 10 can be implemented in an electronic device 101, 102, 104, server 106, or other device(s) in any suitable manner. For example, in some embodiments, the operations and functions shown in or described with respect to FIGS. 2 through 10 can be implemented or supported using one or more software applications or other software instructions that are executed by the processor 120 of the electronic device 101, 102, 104, server 106, or other device(s). In other embodiments, at least some of the operations and functions shown in or described with respect to FIGS. 2 through 10 can be implemented or supported using dedicated hardware components. In general, the operations and functions shown in or described with respect to FIGS. 2 through 10 can be performed using any suitable hardware or any suitable combination of hardware and software/firmware instructions.

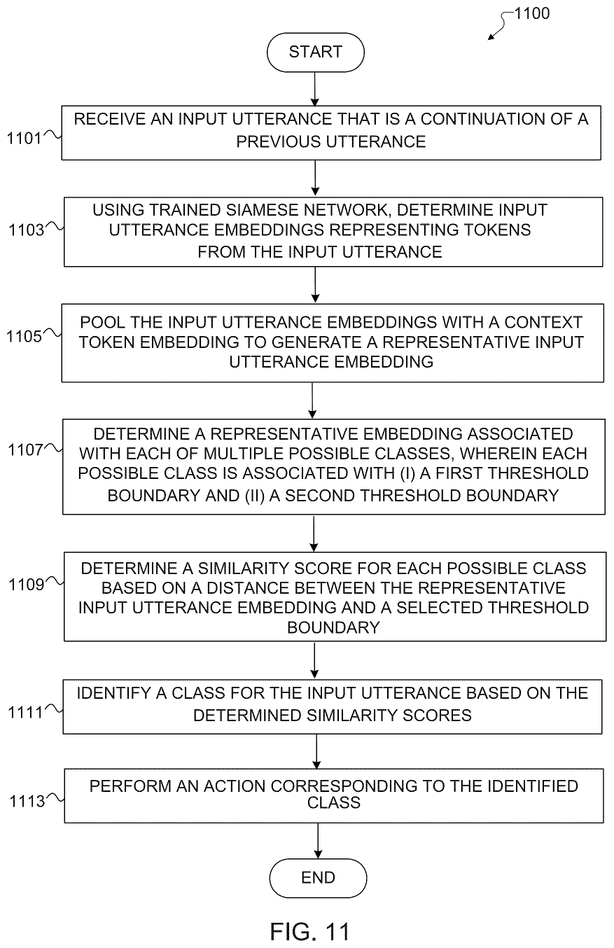

FIG. 11 illustrates an example method 1100 for classifying an input utterance into a class according to this disclosure. For ease of explanation, the method 1100 shown in FIG. 11 is described as involving the use of the electronic device 101 shown in FIG. 1 and a Siamese network 215 that has been trained using the process 200 shown in FIG. 2. However, the method 1100 shown in FIG. 11 could be used with any other suitable process(es) and device(s).

As shown in FIG. 11, an input utterance that is a continuation of a previous utterance is received at step 1101. This could include, for example, the electronic device 101 receiving an input utterance 212 from a user. The input utterance 212 could be spoken by the user into a microphone of the electronic device 101, typed or otherwise input into a touch screen of the electronic device 101 by the user, or obtained in any other suitable manner. Input utterance embeddings representing tokens from the input utterance are determined using a trained Siamese network at step 1103. This could include, for example, the electronic device 101 passing tokens of the input utterance 212 through the LLM 220 to generate token embedding vectors 225. The input utterance embeddings are pooled with a context token embedding representing a class associated with the previous utterance using the Siamese network at step 1105. The pooling generates a representative input utterance embedding. This could include, for example, the electronic device 101 using the pooling layer 230 to pool the token embedding vectors 225 with a context token embedding 304 and generating an utterance embedding vector 235.

A representative embedding associated with each of multiple possible classes is determined using the Siamese network at step 1107. Each possible class is associated with (i) a first threshold boundary that encompasses embeddings of utterances that specify that possible class and (ii) a second threshold boundary that encompasses embeddings of continuation utterances with injected context. This could include, for example, the electronic device 101 selecting a class target 710 for each of multiple possible classes 700. Each class 700 is associated with a regular threshold boundary 711 at a first distance from the class target 710 and a context threshold boundary 712 at a second distance from the class target 710.

A similarity score for each possible class is determined using the Siamese network at step 1109. The similarity score is determined based on a distance between the representative input utterance embedding and a selected threshold boundary of the representative embedding for that possible class, where the selected threshold boundary is the first threshold boundary or the second threshold boundary. This could include, for example, the electronic device 101 using the distance calculation layer 240 to determine one of the in-context similarity scores 721 and 722 or one of the out-of-context similarity scores 731 and 732 for each class 700. In some cases, the electronic device 101 could use one of the distance calculations described above, such as in Equation (2).

A class for the input utterance is identified using the Siamese network at step 1111 based on the determined similarity scores. This could include, for example, the electronic device 101 using the distance calculation layer 240 to identify a predicted class 245 for the input utterance 212 based on the determined similarity scores 721, 722, 731, 732. An action is performed corresponding to the identified class at step 1113. This could include, for example, the electronic device 101 performing an action corresponding to the predicted class 245. As particular examples, the electronic device 101 could open an app for the user, provide requested information to the user, send information to another device on behalf of the user, and the like.

Although FIG. 11 illustrates one example of a method 1100 for classifying an input utterance into a class, various changes may be made to FIG. 11. For example, while shown as a series of steps, various steps in FIG. 11 could overlap, occur in parallel, occur in a different order, or occur any number of times.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
receiving an input utterance that is a continuation of a previous utterance;
using a trained Siamese network:
determining input utterance embeddings representing tokens from the input utterance;
pooling the input utterance embeddings with a context token embedding representing a class associated with the previous utterance to generate a representative input utterance embedding;
determining a representative embedding associated with each of multiple possible classes, wherein each possible class is associated with (i) a first threshold boundary that encompasses embeddings of utterances that specify that possible class and (ii) a second threshold boundary that encompasses embeddings of continuation utterances with injected context;
determining a similarity score for each possible class based on a distance between the representative input utterance embedding and a selected threshold boundary of the representative embedding for that possible class, the selected threshold boundary comprising the first threshold boundary or the second threshold boundary; and
identifying a class for the input utterance based on the determined similarity scores; and
performing an action corresponding to the identified class.

2. The method of claim 1, wherein:
one of the possible classes comprises an unhandled class for utterances that do not belong to any of the other possible classes, and
the unhandled class is associated with a specified similarity score or another score given by a negative soft maximum of the similarity scores of the other possible classes.

3. The method of claim 1, wherein the input utterance embeddings are pooled using a mean pooling technique.

4. The method of claim 1, wherein the input utterance embeddings and the context token embedding are pooled using a learnable attention layer and using the context token embedding representing the class associated with the previous utterance as one of a query, a key, or a value.

5. The method of claim 1, wherein the distance between the representative input utterance embedding and the second threshold boundary is greater than the distance between the representative input utterance embedding and the first threshold boundary.

6. The method of claim 1, wherein:
the first threshold boundary is used as the selected threshold boundary when the input utterance is not in context with that possible class; and
the second threshold boundary is used as the selected threshold boundary when the input utterance is in context with that possible class.

7. The method of claim 1, wherein pooling the input utterance embeddings comprises using a representation of the context from the class associated with the previous utterance to further contextualize the input utterance and generate the representative input utterance embedding.

8. The method of claim 1, wherein the Siamese network is trained using a multi-target loss function.

9. An electronic device comprising:
at least one processing device configured to:
receive an input utterance that is a continuation of a previous utterance;
use a trained Siamese network to:
determine input utterance embeddings representing tokens from the input utterance;
pool the input utterance embeddings with a context token embedding representing a class associated with the previous utterance to generate a representative input utterance embedding;
determine a representative embedding associated with each of multiple possible classes, wherein each possible class is associated with (i) a first threshold boundary that encompasses embeddings of utterances that specify that possible class and (ii) a second threshold boundary that encompasses embeddings of continuation utterances with injected context;
determine a similarity score for each possible class based on a distance between the representative input utterance embedding and a selected threshold boundary of the representative embedding for that possible class, the selected threshold boundary comprising the first threshold boundary or the second threshold boundary; and
identify a class for the input utterance based on the determined similarity scores, and
perform an action corresponding to the identified class.

10. The electronic device of claim 9, wherein:
one of the possible classes comprises an unhandled class for utterances that do not belong to any of the other possible classes, and
the unhandled class is associated with a specified similarity score or another score given by a negative soft maximum of the similarity scores of the other possible classes.

11. The electronic device of claim 9, wherein the at least one processing device is configured to pool the input utterance embeddings using a mean pooling technique.

12. The electronic device of claim 9, wherein the at least one processing device is configured to pool the input utterance embeddings using a learnable attention layer and using the context token embedding representing the class associated with the previous utterance as one of a query, a key, or a value.

13. The electronic device of claim 9, wherein the distance between the representative input utterance embedding and the second threshold boundary is greater than the distance between the representative input utterance embedding and the first threshold boundary.

14. The electronic device of claim 9, wherein:
the first threshold boundary is used as the selected threshold boundary when the input utterance is not in context with that possible class; and
the second threshold boundary is used as the selected threshold boundary when the input utterance is in context with that possible class.

15. The electronic device of claim 9, wherein, to pool the input utterance embeddings, the at least one processing device is configured to use a representation of the context from the class associated with the previous utterance to further contextualize the input utterance and generate the representative input utterance embedding.

16. The electronic device of claim 9, wherein the Siamese network is trained using a multi-target loss function.

17. A non-transitory machine-readable medium containing instructions that when executed cause at least one processor of an electronic device to:
receive an input utterance that is a continuation of a previous utterance;
use a trained Siamese network to:
determine input utterance embeddings representing tokens from the input utterance;
pool the input utterance embeddings with a context token embedding representing a class associated with the previous utterance to generate a representative input utterance embedding;
determine a representative embedding associated with each of multiple possible classes, wherein each possible class is associated with (i) a first threshold boundary that encompasses embeddings of utterances that specify that possible class and (ii) a second threshold boundary that encompasses embeddings of continuation utterances with injected context;
determine a similarity score for each possible class based on a distance between the representative input utterance embedding and a selected threshold boundary of the representative embedding for that possible class, the selected threshold boundary comprising the first threshold boundary or the second threshold boundary; and
identify a class for the input utterance based on the determined similarity scores; and
perform an action corresponding to the identified class.

18. The non-transitory machine-readable medium of claim 17, wherein:
one of the possible classes comprises an unhandled class for utterances that do not belong to any of the other possible classes, and
the unhandled class is associated with a specified similarity score or another score given by a negative soft maximum of the similarity scores of the other possible classes.

19. The non-transitory machine-readable medium of claim 17, wherein the instructions when executed cause the at least one processor to pool the input utterance embeddings using a mean pooling technique.

20. The non-transitory machine-readable medium of claim 17, wherein the instructions when executed cause the at least one processor to pool the input utterance embeddings and the context token embedding using a learnable attention layer and using the context token embedding representing the class associated with the previous utterance as one of a query, a key, or a value.
